(19) United States
(12) Patent Application Publication
(10) Pub. No.: US 2007/0299957 A1
(43) Pub. Date: Dec. 27, 2007

(54) Method and System for Classifying Networked Devices

(76) Inventors: John F. Bevilacqua, Hayward, CA (US); Paul Nehse, Livermore, CA (US); Mike Thiels, Gilroy, CA (US)

Correspondence Address: DICKSTEIN SHAPIRO LLP, 1825 EYE STREET NW, Washington, DC, 20006-5403, US

(21) Appl. No.: 11/662,950

(22) PCT Filed: Sep. 22, 2005
(86) PCT No.: PCT/US05/34208

§ 371 Date: May 9, 2007

Related U.S. Application Data
(60) Provisional application No. 60/611,806, filed on Sep. 22, 2004.

(51) Int. Cl. G06F 7/00

(52) U.S. Cl. 709/223

(57) ABSTRACT

The present invention is a method of creating and assigning a class of storage that is defined by the customer at initialization, such that specific object code is assigned to and used by the devices in a class of storage and such that the devices themselves are grouped according to class of storage. This method provides the customer with greater system design flexibility over conventional naming standards and also provides greater data integrity and security. The method of the present invention includes the steps of assigning a class of storage label, storing the class of storage label, determining whether the device is the correct class of storage for the assigned sub-device group, delivering an error message if the class of storage is incorrect, and assigning the device to a sub-device group, if the class of storage is correct.

### CROSS-REFERENCE TO RELATED APPLICATIONS

This application claims the benefit of U.S. Provisional Application Ser. No. 60/611,806, filed Sep. 22, 2004 in the U.S. Patent and Trademark Office, the entire content of which is incorporated by reference herein.

### FIELD OF THE INVENTION

The present invention-relates to customizing the operating characteristics of redundant arrays of inexpensive disks (RAIDs) and, more specifically, to a method and system for classifying storage devices, such that the user has greater flexibility in system design and data integrity is preserved.

### BACKGROUND OF THE INVENTION

Currently, RAID systems are the principle storage architecture for large, networked computer storage systems. RAID architecture was first documented in 1987 when Patterson, Gibson, and Katz published a paper entitled, “A Case for Redundant Arrays of Inexpensive Disks (RAID)” (University of California, Berkeley). Fundamentally, RAID architecture combines multiple small, inexpensive disk drives into an array of disk drives that yields performance that exceeds that of a Single Large Expensive Drive (SLED). Additionally, this array of drives appears to the computer to be a single logical storage unit (LSU) or drive. Five types of array architectures, designated as RAID-1 through RAID-5, were defined by the Berkeley paper, each providing disk fault-tolerance and each offering different trade-offs in features and performance. In addition to these five redundant array architectures, a non-redundant array of disk drives is referred to as a RAID-0 array. RAID controllers provide data integrity through redundant data mechanisms, high speed through streamlined algorithms, and accessibility to the data for users and administrators.

A networking technique that is fundamental to the various RAID levels is “striping,” a method of concatenating multiple drives into one logical storage unit. Striping involves partitioning each drive's storage space into stripes, which may be as small as one sector (512 bytes) or as large as several megabytes. These stripes are then interleaved round-robin, so that the combined space is composed alternately of stripes from each drive. In effect, the storage space of the drives is shuffled like a deck of cards. The type of application environment, I/O or data intensive, determines whether large or small stripes should be used. The choice of stripe size is application dependant and affects the real-time performance of data acquisition and storage in mass storage networks. In data intensive environments and single-user systems which access large records, small stripes (typically one 512-byte sector in length) can be used, so that each record will span across all the drives in the array, each drive storing part of the data from the record. This causes long record accesses to be performed faster, because the data transfer occurs in parallel on multiple drives. Applications such as on-demand video/audio, medical imaging, and data acquisition, which utilize long record accesses, will achieve optimum performance with small stripe arrays.

In addition to stripe size, a number of other parameters also affect the real-time performance of mass storage networks. For, example database applications require optimized data integrity and, therefore, offer robust error handling policies and drive redundancy strategies, such as data mirroring. Real-time video applications require high throughput and dynamic caching of data, but are less optimized with regard to data integrity. Consequently, most memory networks are customized or “tuned” to their specific application. The operation of most standard RAID controllers is set at the Application Programming Interface (API) level. Typically, Original Equipment Manufacturers (OEMs) bundle RAID networks and sell these memory systems to end users for network storage. OEMs bear the burden of customization of a RAID network and tune the network performance through an API. However, the degree to which a RAID system can be optimized through the API is limited. The API does not adequately handle the unique performance requirements of various dissimilar data storage applications. Additionally, the API does not provide an easily modifiable and secure format for proprietary OEM RAID configurations.

Furthermore, end users, such as system administrators have fewer opportunities to configure the RAID systems in order to optimize the networks for their specific organizations and applications. In conventional RAID systems, the devices attached to the RAID network are grouped according to a normal disk naming convention referred to as cntndnsn, where cn is the controller number, tn is the target, dn is the disk, and sn is the slice. However, this naming convention does not provide flexibility for grouping resources according to other means, such as departments or functions. It also does not provide a simple naming convention that would be more easily understood and managed.

What is needed is a method of allowing a system user or administrator to easily classify all the storage devices within a RAID system (e.g., by department or function), such that the system itself is more easily managed and data is secure from other system users.

An example RAID management technique is described in US Patent Application Publication No. 2004/0025162 entitled, “Data Storage Management System and Method.” The invention relates to methods and associated systems for managing application workloads and data storage resources. Techniques are disclosed for determining the I/O capacity of a data storage resource for a given workload and allocating resources according to administrator requirements. The invention of the '162 application may be implemented as a transparent layer between the application and the data storage resource, for example, in the file system. For example, one embodiment of a system constructed according to the invention of the '162 application allocates data storage resources (i.e., hardware and/or software for storing data) to applications in order to achieve desired levels of system performance. To this end, various embodiments for mapping I/O demand to I/O capacity, determining response times in the system, and allocating the application workload and/or system resources are described.

The '162 application also describes a workflow name space that allows customers to allocate resources and monitor resource utilization through a naming convention that reflects the company organization, for example, along departmental boundaries. Although the '162 application describes a method of assigning system resources based on specific application and system administrator requirements, it does not provide a means for a system administrator to have control over system resource groupings, such that storage allocation is maintained within the group.

What is needed is a way for customers to allocate resources and monitor resource utilization through a naming convention that reflects a customized physical or logical grouping, while providing the system administrator with control over system resource groupings, such that storage allocation is maintained within the group to ensure data integrity and security. For example, a group of resources that are assigned to a financial department have an added layer of security, because resources assigned to the financial department cannot contain any volumes which are assigned to another department.

It is therefore an object of the invention to provide a user with configuration capability for a networked storage RAID system, such that the RAID network is easily customized for resource allocation and monitoring utilization.

It is another object of this invention to ensure data integrity and security among multiple system users in a networked storage RAID system, by providing control over system resource groupings.

### BRIEF SUMMARY OF THE INVENTION

The present invention provides a method for classifying each of a plurality of networked devices. The method includes the step of creating a plurality of classification categories to describe the properties of each of the plurality of networked devices. A classification label is assigned to a device of the plurality of networked devices. The classification label references one or more of the plurality of classification categories. Assignment data is stored on the network controller. The device is grouped among other similarly assigned devices of the plurality of networked devices.

The present invention also provides a system for classifying each of a plurality of networked devices. The system includes a plurality of networked devices and a network controller. The network controller is configured to store a plurality of classification categories that describe the properties of each of the plurality of networked devices. The system also includes a remote user configured to both assign a classification label to a device of the plurality of networked devices, the classification label referencing one or more of the plurality of classification categories, and to group the device among other similarly assigned devices of the plurality of networked devices. Communication means also allow transmission of signals between the remote user and the network controller, and between the network controller and each of the plurality of networked devices.

These and other aspects of the invention will be more clearly recognized from the following detailed description of the invention which is provided in connection with the accompanying drawings.

### BRIEF DESCRIPTION OF THE DRAWINGS

FIG. 1 illustrates a block diagram of a conventional RAID networked storage system in accordance with an embodiment of the invention.

FIG. 2 illustrates a block diagram of a RAID controller system in accordance with an embodiment of the invention.

FIG. 3 illustrates a block diagram of RAID controller hardware for use with an embodiment of the invention.

FIG. 4 illustrates a block diagram that further details the system manager for use with an embodiment of the invention.

FIG. 5 illustrates a flow diagram of a method of assigning a class of storage in accordance with an embodiment of the invention.

### DETAILED DESCRIPTION OF THE INVENTION

The present invention is a method and system for classifying storage devices within a RAID architecture and, more specifically, it is a method and system for storage classification that is definable by the system administrator and that provides greater configuration flexibility.

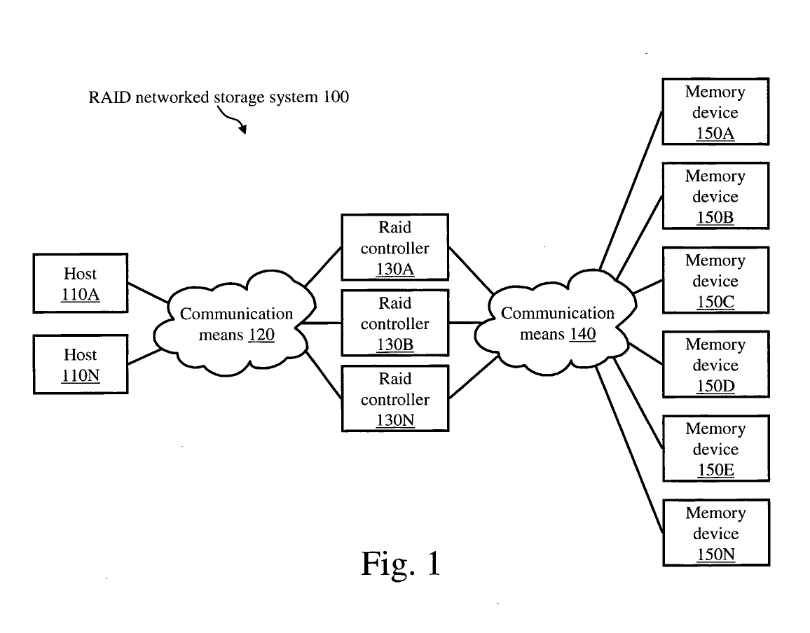

FIG. 1 is a block diagram of a conventional RAID networked storage system 100 that combines multiple small, inexpensive disk drives into an array of disk drives that yields superior performance characteristics, such as redundancy, flexibility, and economical storage. Conventional RAID networked storage system 100 includes a plurality of hosts 110A through 110N, where ‘N’ is not representative of any other value ‘N’ described herein. Hosts 110 are connected to a communications means 120, which is further coupled via host ports (not shown) to a plurality of RAID controllers 130A and 130B through 130N, where ‘N’ is not representative of any other value ‘N’ described herein. RAID controllers 130 are connected through device ports (not shown) to a second communication means 140, which is further coupled to a plurality of memory devices 150A through 150N, where ‘N’ is not representative of any other value ‘N’ described herein. Memory devices 150 are housed within enclosures (not shown).

Hosts 110 are representative of any computer systems or terminals that are capable of communicating over a network. Communication means 120 is representative of any type of electronic network that uses a protocol, such as Ethernet. RAID controllers 130 are representative of any storage controller devices that process commands from hosts 110 and, based on those commands, control memory devices 150. RAID controllers 130 also provide data redundancy, based on system administrator programmed RAID levels. This includes data mirroring, parity generation, and/or data regeneration from parity after a device failure. Physical to logical and logical to physical mapping of data is also an important function of the controller that is related to the RAID level in use. Communication means 140 is any type of storage controller network, such as iSCSI or fibre channel. Memory devices 150 may be any type of storage device, such as, for example, tape drives, disk drives, non-volatile memory, or solid state devices. Although most RAID architectures use disk drives as the main storage devices, it should be clear to one skilled in the art that the invention embodiments described herein apply to any type of memory device.

In operation, host 110A, for example, generates a read or a write request for a specific volume, (e.g., volume 1), to which it has been assigned access rights. The request is sent through communication means 120 to the host ports of RAID controllers 130. The command is stored in local cache in, for example, RAID controller 130B, because RAID controller 130B is programmed to respond to any commands that request volume 1 access. RAID controller 130B processes the request from host 110A and determines the first physical memory device 150 address from which to read data or to write new data. If volume 1 is a RAID 5 volume and the command is a write request, RAID controller 130B generates new parity, stores the new parity to the parity memory device 150 via communication means 140, sends a “done” signal to host 110A via communication means 120, and writes the new host 110A data through communication means 140 to the corresponding memory devices 150.

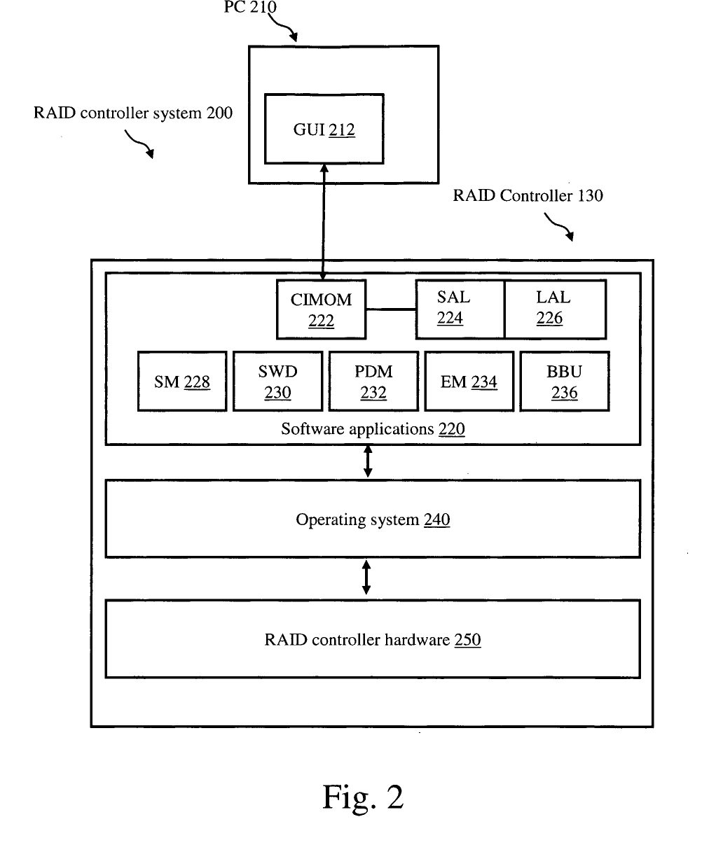

FIG. 2 is a block diagram of a RAID controller system 200. RAID controller system 200 includes RAID controllers 130 and a general purpose personal computer (PC) 210. PC 210 further includes a graphical user interface (GUI) 212. RAID controllers 130 further include software applications 220, an operating system 240, and a RAID controller hardware 250. Software applications 220 further include a common information module object manager (CIMOM) 222, a software application layer (SAL) 224, a logic library layer (LAL) 226, a system manager (SM) 228, a software watchdog (SWD) 230, a persistent data manager (PDM) 232, an event manager (EM) 234, and a battery backup (BBU) 236.

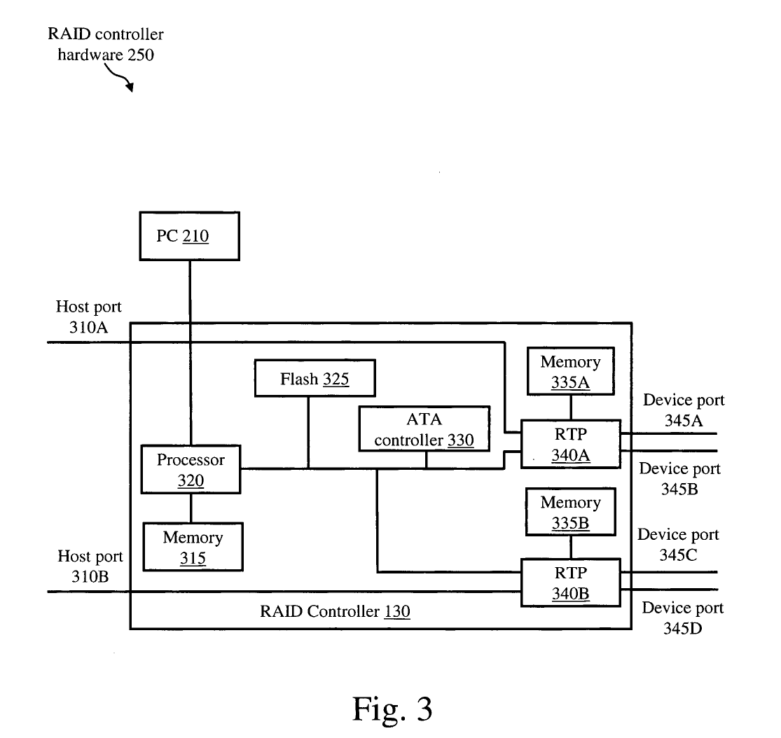

GUI 212 is a software application used to input personality attributes for RAID controllers 130. GUI 212 runs on PC 210. RAID controllers 130 are representative of RAID storage controller devices that process commands from hosts 110 and, based on those commands, control memory devices 150. As shown in FIG. 2, RAID controllers 130 are an exemplary embodiment of the invention; however, other implementations of controllers may be envisioned here by those skilled in the art. RAID controllers 130 provide data redundancy, based on system-administrator-programmed RAID levels. This includes data mirroring, parity generation, and/or data regeneration from parity after a device failure. RAID controller hardware 250 is the physical processor platform of RAID controllers 130 that executes all RAID controller software applications 220 and that include a microprocessor, memory, and all other electronic devices necessary for RAID control, as described, in detail, in the discussion of FIG. 3. Operating system 240 is an industry-standard software platform, such as Linux, for example, upon which software applications 220 can run. Operating system 240 delivers other benefits to RAID controllers 130. Operating system 240 contains utilities, such as a file system, that provide a way for RAID controllers 130 to store and transfer files. Software applications 220 contain algorithms and logic necessary for the RAID controllers 130 and are divided into those needed for initialization and those that operate at run-time. Initialization software applications 220 include the following software functional blocks: CIMOM 222, which is a module that instantiates all objects in software applications 220 with the personality attributes entered, SAL 224, which is the application layer upon which the run-time modules execute, and LAL 226, a library of low-level hardware commands used by a RAID transaction processor, as described in the discussion of FIG. 3.

Software applications 220 that operate at run-time include the following software functional blocks: SM 228, a module that carries out the run-time executive; SWD 230, a module that provides software supervision function for fault management; PDM 232, a module that handles the personality data within software applications 220; EM 234, a task scheduler that launches software applications 220 under conditional execution; and BBU 236, a module that handles power bus management for battery backup.

FIG. 3 is a block diagram of RAID controller hardware 250. RAID controller hardware 250 is the physical processor platform of RAID controllers 130 that executes all RAID controller software applications 220 and that includes host ports 310A and 310B, memory 315, a processor 320, a flash 325, an Advanced Technology Attachment (ATA) controller 330, memory 335A and 335B, RAID transaction processors (RTP) 340A and 340B, and device ports 345A through D.

Host ports 310 are the input for a host communication channel, such as an iSCSI or a fibre channel (not shown).

Processor 320 is a general purpose micro-processor IBM PowerPC 405 that executes software applications 220 that run under operating system 240.

PC 210 is a general purpose personal computer that is used to input personality attributes for RAID controllers 130 and to provide the status of RAID controllers 130 and memory devices 150 during run-time. PC 210 is connected to processor 320 via a communication port (e.g. Ethernet). During run-time, processor 320 sends information to PC 210 regarding errors and other system diagnostics.

Memory 315 is volatile processor memory, such as synchronous DRAM.

Flash 325 is a physically removable, non-volatile storage means, such as an EEPROM. Flash 325 stores the personality attributes for RAID controllers 130.

ATA controller 330 provides low-level disk controller protocol for Advanced Technology Attachment protocol memory devices.

RTP 340 provides RAID controller functions on an integrated circuit and uses memory 335A and 335B for cache.

Memory 335 A and 335B are volatile memory, such as synchronous DRAM.

Device ports 345 are memory storage communication channels, such as iSCSI or fibre channels.

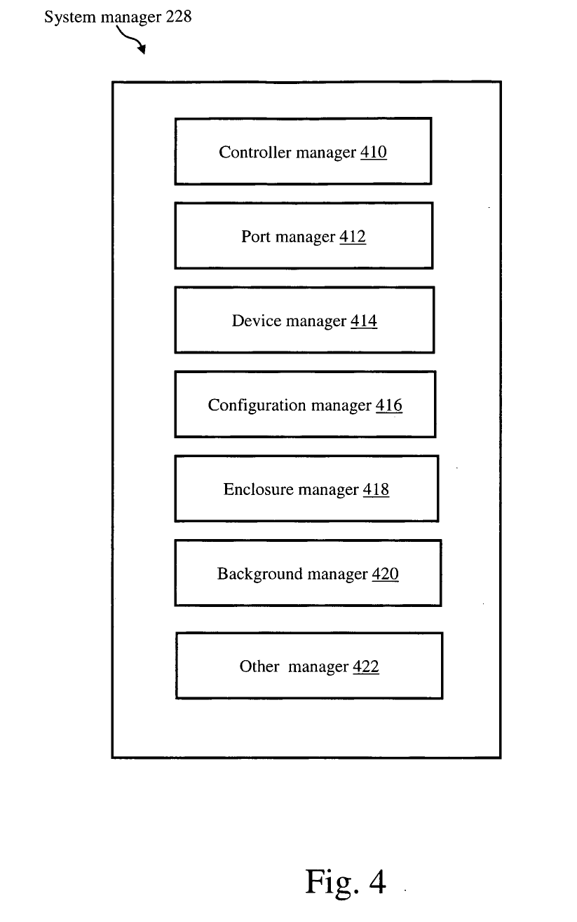

FIG. 4 is a block diagram that further details SM 228 within software applications 220. SM 228 includes a controller manager 410, a port manager 412, a device manager 414, a configuration manager 416, an enclosure manager 418, a background manager 420, and an other manager 422.

SM 228 is formed of the following configurable software constructs that have unique responsibilities for handling data within RAID controllers 130:

Controller manager 410 is a software module that directs caching, implements statistics gathering, and handles error policies, such as loss of power or loss of components, for example.

Port manager 412 is a software module that is responsible for fiber port configuration, path balancing, error policies handling for port error issues such as loss of sync or cyclic redundancy codes (CRC) errors.

Device manager 414 handles device naming, class of storage, and error policies such as device level errors, for example, class of storage errors, command retry errors, media command errors, and port errors.

Configuration manager 416 handles volume policies, such as, for example, volume caching, pre-fetch, LUN permissions, and RAID policies, including reading mirrors and recovering alternate devices.

Enclosure manager 418 handles hardware system support elements, such as fan speed and power supply output voltages.

Background manager 420 provides ongoing support maintenance functionality to disk management including, for example, device health check, device scan, and the GUI data refresh rate.

Other manager 422 is representative of other managers that may be employed within RAID controllers 130. Other managers may be envisioned here by those skilled in the art, and the invention is not limited to use with only the managers described in FIG. 4.

With reference to FIGS. 2 through 4, the operation of RAID controllers 130 is described as follows:

Unique customer requirements for RAID network behavior and performance are entered into an interactive menu-driven GUI application (not shown) that runs on a general-purpose computer, such as, for example, a personal computer (PC) (not shown). These customer requirements include the attributes of SM 228, as described in the discussion of FIG. 4, and include, but are not limited to, for example, volume and cache behavior; water marks for flushing cache; prefetch behavior, i.e., setting the number of blocks to prefetch; error recovery behavior, i.e., number of retry times; path balancing; fibre channel port behavior, i.e., number and type of time outs; and Buffer to Buffer credit (BB). As a result of this process, an XML computer file (not shown) is generated that contains a profile of RAID attributes described as “personality” data. A compact flash image is built for the XML personality data and is programmed into a removable, compact flash 325, by a standard industry flash programmer (not shown), after which the compact flash 325 is installed into RAID controller hardware 250. At startup time, RAID controllers 130 are initialized, and the XML personality data is loaded. The XML personality data provides customization of software constructs within SM 228. This customization provides RAID controllers 130 with a way for the behavior, or “personality,” of RAID controllers 130 to be customized, based on their intended application, as defined by the customer.

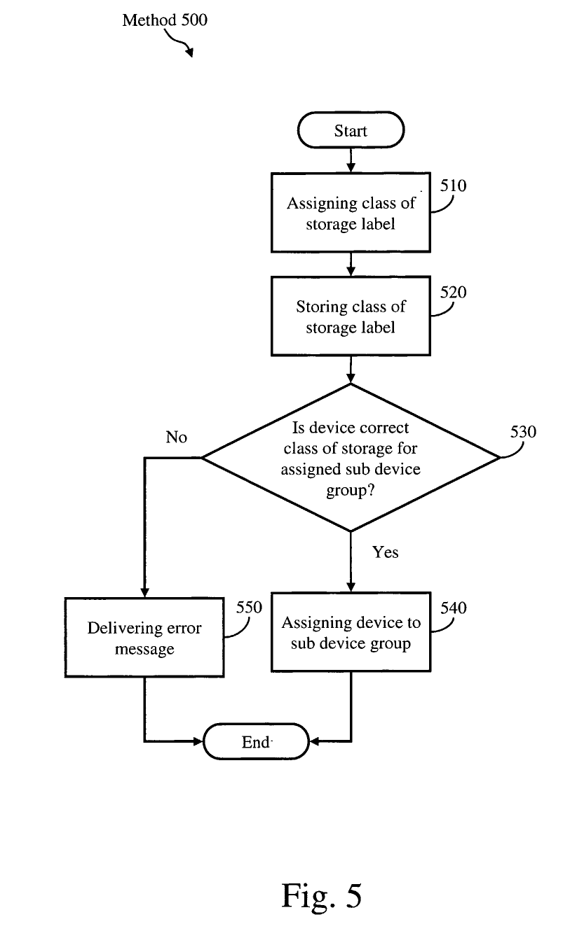

FIG. 5 is a method 500 of assigning and using a class of storage.

Step 510: Assigning Class of Storage Label

In this step, a customer, such as a corporate systems administrator, creates an ASCII label for a specific device by using GUI 212 and device manager 414. The ASCII label may be any byte length; for example, thirty-two bytes provides adequate flexibility. The device label represents a class of storage tag and may be assigned any value or nomenclature, as devised by the customer. For example, a class of storage may be a physical attribute such as capacity, spindle rotation speed, or device type. Class of storage may also be a logical attribute, such as departments, functions, or user accounts. At system initialization, all devices default to the same class of storage. Method 500 proceeds to step 520.

Step 520: Storing Class of Storage Label

In this step, SM 228 stores the label developed by the customer in step 510 and assigns the appropriate object code to that device. For example, the customer may assign a class of storage called “engineering” to a device because, it will be used by the engineering department. SM 228 stores the tag “engineering,” along with other object code that defines volume policies for that particular class of storage, in the configuration section of the device. Method 500 proceeds to step 530.

Step 530: Is Device the Correct Class of Storage for the Assigned Sub-Device Group?

In this decision step, a customer assigns a device to a sub-device group. SM 228 checks to see whether the device is (1) not already assigned to another sub-device group and (2) that the class of storage assigned to the device is that of the sub-device group to which it is being assigned. If either (1) or (2) are false, then method 500 proceeds to step 550. If (1) and (2) are true, method 500 proceeds to step 540.

Step 540: Assigning Device to a Sub-Device Group

In this step, configuration manager 416 assigns the device to the sub-device group chosen by the customer. The device is now ready for band and volume allocation. Method 500 ends.

Step 550: Delivering Error Message

In this step, SM 228 creates an error message, depending on the type of error. For case (1), the error message tells the customer that the device that he or she is trying to assign to a sub-device group is already assigned to another sub-device group. For case (2), SM 228 tells the customer that the class of storage assigned to the device is not the same as that in the sub-device group and, therefore, cannot be assigned to that sub-device group. Method 500 ends.

Therefore, the method of the present invention gives a customer the ability to assign any class of storage to any device and to group like-classes of storage devices together for ease of management and maintenance. Furthermore, this invention allows object code to be used by each of the devices according to their particular class of storage, which increases data integrity and security.

Although the present invention has been described in relation to particular embodiments thereof, many other variations and modifications and other uses will become apparent to those skilled in the art. Therefore, the present invention is to be limited not by the specific disclosure herein, but only by the appended claims.

1. A method for classifying each of a plurality of networked devices, comprising:
creating a plurality of classification categories to describe the properties of each of the plurality of networked devices;
assigning a classification label to a device of the plurality of networked devices, the classification label referencing one or more of the plurality of classification categories;
storing assignment data on the network controller; and
grouping the device with other similarly assigned devices of the plurality of networked devices.

2. The method of claim 1, wherein the step of creating a plurality of classification categories is performed at a terminal remote from the network controller.

3. The method of claim 1, wherein the step of assigning a classification label is performed manually by a user.

4. The method of claim 1, wherein the step of grouping the device further comprises ensuring that the device is not already a member of a group of other devices of the plurality of networked devices.

5. The method of claim 4, wherein an error signal is generated if the device is either already a member of a group of other devices of the plurality of networked devices or if the device is assigned a classification label that differs from the classification label of the other devices of the plurality of networked devices.

6. The method of claim 1, wherein the network controller is a redundant array of independent disks (RAID) controller, and the plurality of networked devices are storage devices in a RAID system.

7. A system for classifying each of a plurality of networked devices, comprising:
a plurality of networked devices;
a network controller configured to store a plurality of classification categories that describe the properties of each of the plurality of networked devices;
a remote user configured to both assign a classification label to a device of the plurality of networked devices, the classification label referencing one or more of the plurality of classification categories, and to group the device among other similarly assigned devices of the plurality of networked devices; and
communication means to allow transmission of signals between the remote user and the network controller, and between the network controller and each of the plurality of networked devices.

8. The system of claim 7, wherein the assignment of a classification label is performed manually by the remote user.

9. The system of claim 7, wherein the remote user further ensures that the device is not already a member of a group of other devices of the plurality of networked devices.

10. The system of claim 9, wherein the network controller generates an error signal if the device is either already a member of a group of other devices of the plurality of networked devices or if the device is assigned a classification label that differs from the classification label of the other devices of the plurality of networked devices.

11. The system of claim 7, wherein the network controller is a redundant array of independent disks (RAID) controller, and the plurality of networked devices are storage devices in a RAID system.
